(19) United States
(12) Patent Application Publication
(10) Pub. No.: US 2023/0174351 A1
(43) Pub. Date: Jun. 8, 2023

(54) Carriage

(71) Applicant: Andreas Zaglacher, Niederndorf (AT)

(72) Inventor: Andreas Zaglacher, Niederndorf (AT)

(21) Appl. No.: 17/766,981

(22) PCT Filed: Oct. 6, 2020
(86) PCT No.: PCT/EP2020/077989

§ 371 Date: Apr. 20, 2022

(30) Foreign Application Priority Data
Oct. 7, 2019 (AT) A 323/2019

(51) Int. Cl. B66C 21/04; A01G 23/00; B66C 13/46; B66C 13/48; B66C 13/44

(52) U.S. Cl. CPC B66C 21/04; A01G 23/003; B66C 13/44; B66C 13/46; B66C 13/48

(57) ABSTRACT

The present invention relates to a grapple carriage for uphill, downhill and horizontal cabling of lumber and long goods. The carriage determines its absolute and relative position in space by means of a learning run or measuring run. During this run, a topographic ground profile and/or altitude profile is produced, and the position of the trees or long goods to be transported is analyzed. A central open-loop and/or closed-loop control unit processes all the machine status information which has been recorded and/or transmitted by the winch or yarder.

### DESCRIPTION

The present invention is used in forestry for harvesting lumber or also for transporting lumber and other long goods, cable crane systems. These systems consist of a cable crane which is pulled by means of a cable or travels self-propelled on a cable. The cables are pulled by means of winch units on carrier vehicles (tilt boom, yarder, etc.) or a fixed installation. Systems commonly used in the industry are referred to as “standing skyline”, “live skyline” or “running skyline”. The cable cranes and winch units used for this purpose vary widely in their design and are adapted to the respective application requirements.

The invention can be used for uphill, downhill and/or also horizontal cabling over flat and non-trafficable terrain.

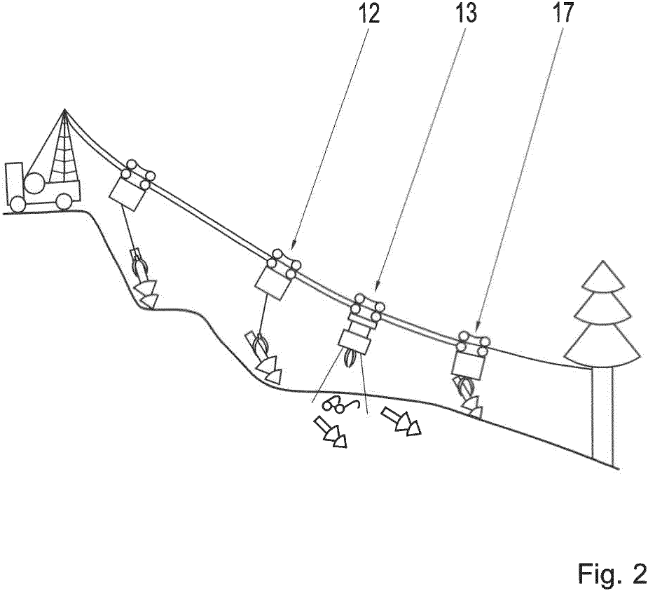

The cable cranes of the present invention can apply the force for transport through the motor power of a winch, gravitational force or self-propulsion. For this purpose, all types of drive corresponding to the state of the art can be used; hybrid solutions are also in use.

Whereas both cable cranes with a forced spooling system and hoisting winch cable cranes remain on the carrier cable and only the cable is lowered, in the case of a grapple cable crane the tongs must be lowered to the ground so that trees lying on the ground can be picked up using the tongs (cf. FIG. 2). According to the current state of the art, for this purpose the position of the grapple cable crane, i.e. the length traveled on the cable, is shown on a display and the trees or the long goods are recorded and transmitted to the operator by means of a camera that is oriented towards the ground and that may be pivotable. Using this information, the operator lowers the gripper and/or attempts to grip the trees or the long goods in a manner suitable for transport. The trees or the long goods are positioned with their thicker end below the cableway by felling or removal. At the thicker end, the trees are gripped and pulled uphill, downhill or horizontally with the crown sliding along the ground. As far as possible, the trees should be prevented from hanging or swinging freely, as otherwise there is a risk that the end of the tree will damage or snag on the carriage, carrier cable, carrier cable saddle or support tree. This is ensured by permanent transport monitoring and manual control or readjustment by the operator of the system.

A grapple cable crane is a cable crane with a tong-like gripper. The grapple is a partial and/or full wrap-around method of gripping the lumber and/or long goods.

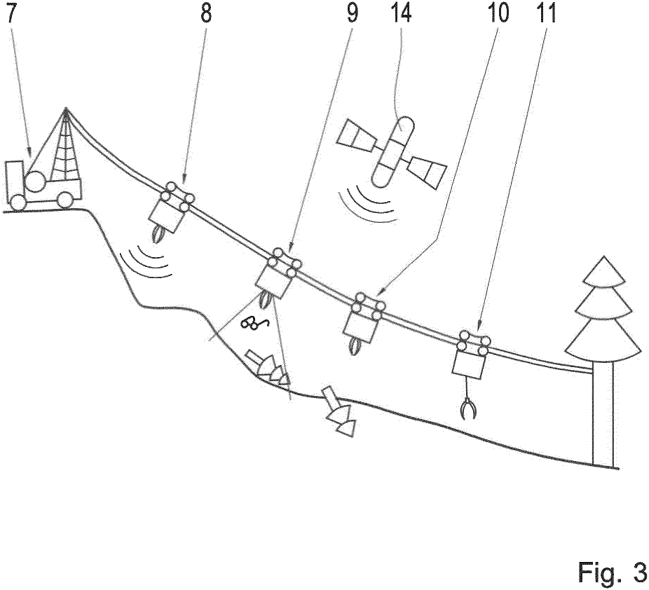

This invention now provides that the grapple carriage detects both its absolute and relative position in three-dimensional space by means of a learning run. Using machine data about the cable unwinding and/or barometric and/or satellite-based and/or radiation-enabled location determination, the central open-loop and/or closed-loop control unit thus obtains the position of the carriage in space. The distance to the ground and thus the topography of the terrain can be determined by a sensor system which is mounted in the carriage and suitable for direct and/or indirect measuring methods. Alternatively, the topography (also called the ground profile hereinafter) can also be used if already known through other methods. The information on the ground profile is fed into the central open-loop and/or closed-loop control unit. A further option for detecting the ground profile is pulling an altitude and position sensor over the ground profile by means of a carriage and/or cable crane (FIG. 3, item 1).

The position of the trees or the long goods is detected by the recorded scan data of the ground profile surface during the learning run by analysis software and the location-determining data are transmitted to the central open-loop and/or closed-loop control unit. The learning run can also take place when the carriage is lowered. The length of the trees is known to the operator and is entered into the open-loop and/or closed-loop control unit as master data. Alternatively, in this case the information on the position of the trees in space or of the long goods can also be taken from other sources (for example, from a worker on the terrain and/or a machine which fells the trees) and used in the central open-loop and/or closed-loop control unit. Based on the detected trunk diameter and the tree species and moisture specified by the operator, the central open-loop and/or closed-loop control unit calculates the weight of the transported goods.

The learning run (measuring run) can be repeated as often as desired, provided that the terrain or the position of the trees or the long goods changes significantly.

Fixed points in the cableway, such as e.g. supports, stops or a landing position can be read for regular readjustment in the open-loop and/or closed-loop control unit when they are approached or passed.

The information known to the open-loop and/or closed-loop control unit, after the measuring run/learning run, is used to create the cycle for removal transport, which cycle can be influenced by selected specifications of the operator (e.g. cycle time for depositing the tree at the landing location). The operator starts the program and the grapple carriage transports all the trees to the landing position in single or multiple transport operations, with the trees being deposited in between if necessary. The gripping position, i.e. the distance from the interface to the grab position, is specified and the grapple carriage sets the tongs accordingly.

The central open-loop and/or closed-loop control unit is responsible for ensuring that the crown of the tree is in contact with the ground. The data on the ground profile and the shortest tree or long goods item picked up in the grapple are calculated for this purpose, as are the tensile force, cable length and the towing position thus computed. The height is thus adjusted via the spooled-out cable or the tension of the carrier cable.

Using the actual tension on the winch or the tension on the tipping mast, yarder or grapple carriage, the control loop is closed and operator intervention is requested in the event of a deviation from the expected values.

The grapple carriage works semi-autonomously, i.e. no operator intervention is necessary during normal operation. Only faults have to be corrected and master data (lumber length, lumber type, moisture, position of supports, etc.) have to be entered.

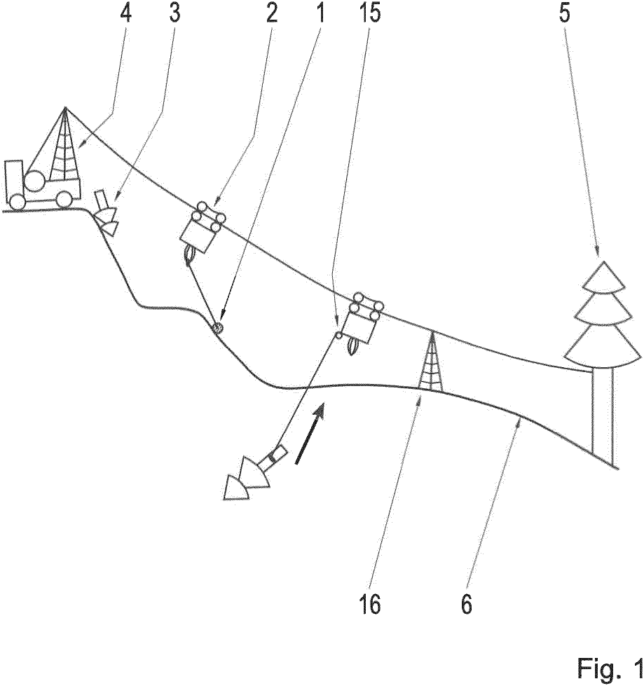

The grapple carriage can be designed as a fixed carriage on the cable either with the roller combination resting on the cable or enclosing the cable. Alternatively, the grapple carriage can also be lowered (cf. FIG. 1, item 2).

A cable winch is mounted on the grapple carriage, and can be used in manual operation to pull trees that lie outside the cableway (i.e. the area below the tensioned cable) into the cableway. The cable winch is mounted fixedly and/or removably on the carriage in order to be able to reduce the weight of the carriage if necessary.

Image description
1. Sensor towed on the ground by carriage to determine the ground and/or altitude profile
2. Grapple carriage which tows the sensor uphill and/or downhill and/or horizontally
3. Tree deposited at landing location
4. Symbol image for winch unit, tipping mast, yarder or other cable pulling machines
5. Fixed point for cable attachment
6. Ground and/or altitude profile of the landscape
7. Winch with measuring technology for returning machine parameters to the open-loop and/or closed-loop control unit 8. Grapple carriage determining the ground and/or altitude profile
9. Grapple carriage recording the ground structure to detect the tree position
10. Grapple carriage with retracted tongs
11. Grapple carriage with partially extended tongs
12. Grapple carriage with partially extended tongs and tree or long goods in the tongs; the towed goods are in contact with the ground
13. Grapple carriage with part of the carriage lowered to scan the ground structure and detect trees or long goods
14. Satellite for recording the ground and altitude profile and/or the ground structure
15. Grapple carriage in winch mode for advancing the trees or long goods into the cableway.
16. Support of the carrier cable
17. Grapple carriage with retracted tongs and clamped tree and/or long goods

1. A grapple cable crane for receiving trees and long goods in an immediate vicinity of a cableway, characterized in that the grapple cable crane is configured to:
measure a ground profile and/or altitude profile by means of a learning runs and
transmit said ground profile and/or said altitude profile to a central open-loop and/or closed-loop control unit.

2. The grapple cable crane according to claim 1, characterized in that the ground profile and/or altitude profile is created from already present topographic data and these data are transmitted to the open-loop and/or closed-loop control unit.

3. The grapple cable crane according to claim 1, characterized in that a ground structure is also determined during a run for measuring the altitude profile and the position of the trees or the long goods in space is detected.

4. The grapple cable crane according to claim 3, characterized in that the position of the trees and of the long goods is transmitted to the central open-loop and/or closed-loop control unit by means of measurement in another manner corresponding to the state of the art.

5. The grapple cable crane according to claim 1, characterized in that the ground profile is recorded by means of teach-in, teaching or learning and is transmitted to the central open-loop and/or closed-loop control unit.

6. The grapple cable crane according to claim 1, characterized in that a tow cable with a sensor resting on the ground is pulled over the ground profile, wherein the determining of the ground profile is based on the sensor .

7. The grapple cable crane according to claim 1, characterized in that the-machine data from previous transport runs require a re-analysis of the ground profile .

8. The grapple cable crane according to claim 1, characterized in that the central open-loop and/or closed-loop control unit controls and regulates all machine parameters in such a way that the transported goods are always in contact with the ground .

9. The grapple cable crane according to claim 8, characterized in that transport without ground contact is permitted by manual intervention.

10. The grapple cable crane according to claim 7, characterized in that lumber or long goods are delivered autonomously, .

11. The grapple cable crane according to claim 1, characterized in that a the trees and/or long goods can be transported both simultaneously and by targeted depositing and retrieval.

12. The grapple cable crane according to claim 11, characterized in that a combination of autonomous and manual operation is possible.

13. The grapple cable crane according to claim 1, characterized in that the grapple cable crane is configured to transmit both an absolute and a relative position in space of a carriage and a gripper to the central open-loop and/or closed-loop control unit .

14. The grapple cable crane according to claim 1, characterized in that the cable crane, when lowered just above the ground on an empty run, records the ground structure .

15. The grapple cable crane according to claim 1, characterized in that a_carriage is equipped with a fixedly installed and/or removable additional winch for advancing timber and/or long goods .

16. The grapple cable crane according to claim 1, characterized in that a topography is determined barometrically and/or via satellite and/or by radiation.
